(19) United States
(12) Patent Application Publication
(10) Pub. No.: US 2008/0116753 A1
(43) Pub. Date: May 22, 2008

(54) APPLIANCES WITH BRUSHLESS MOTORS

(76) Inventor: Vito James Carlucci, Stratford, CT (US)

Correspondence Address: Lawrence Cruz;Conair Corporation, One Cummings Point Road, STAMFORD, CT, 06902, US

(21) Appl. No.: 11/939,842

(22) Filed: Nov. 14, 2007

Related U.S. Application Data
(60) Provisional application No. 60/859,745, filed on Nov. 17, 2006.

(51) Int. Cl. H02K 7/14; H02P 7/285; H02K 11/04; H02K 9/06

(52) U.S. Cl. 310/50; 310/63; 310/68 A; 388/816

(57) ABSTRACT

A portable electric appliance (1, 23) such as a hand held hair dryer uses a brushless electric motor (13, 25) in combination with a secondary fan assembly (14) and/or an air scoop (24) to redirect air toward the motor (13, 25), to maintain a cool operating temperature. The appliance includes a control circuit (50, 80, 94, 102, 110) for controlling the brushless motor (13, 25) and other appliance features. The control circuit and the coil windings (21) of the brushless electric motor are designed to run the appliance at a relatively low current to accommodate a higher operating voltage, thereby operating at a low wattage for reducing extraneous or waste heat. This facilitates placement of the control circuit in a small, portable appliance, and may enhance operation of the appliance in certain modes such as a hair dryer “cool shot.”

### CROSS REFERENCE TO RELATED APPLICATIONS

This application claims the benefit of U.S. Provisional Application Ser. No. 60/859,745, filed Nov. 17, 2006, hereby incorporated by reference herein in its entirety.

### FIELD OF THE INVENTION

The present invention relates to portable electrical appliances including, but not limited to, hand held hair dryers, hair clippers, shavers, blenders, and food processors and, more particularly, to electrical appliances that use high speed rotational electric motors.

### BACKGROUND OF THE INVENTION

Small appliances such as hair dryers, clippers, shavers, blenders, food processors, and others that require rotational electric motors use standard electric motors with brush-contact stator and rotor arrangements. Such motors have been in existence for a long time and are reliable, inexpensive, and durable. While they are generally suitable for what is regarded as ordinary performance, there is room for improvement in terms of rotational velocity, torque, size and weight, and life cycle.

Brushless electrical motors have been used in recent years in a very limited set of applications including, most notably, in the field of radio controlled model airplanes. Compared to standard brush motors, brushless motors employ non-contact rotor and stator sets and are much smaller and lighter while having greater torque, velocity and durability. Relatively high costs and cooling challenges, due to higher velocities, have thus far prohibited use beyond specialized industries such as radio controlled model airplanes, where airflow from the movement of the airplane addresses the cooling issues and the high costs are tolerated in hobby and specialized industries.

### SUMMARY OF THE INVENTION

It is an object of the present invention to provide compact, portable appliances such as hair dryers, clippers, shavers, blenders, food processors and others with a brushless electric motor.

This and other objects are achieved by the present invention.

According to an embodiment of the present invention, using a hand held hair dryer as an example, a brushless motor is positioned inside the housing of the hair dryer. The brushless motor has a stator with an array of electromagnetic coils/windings, a rotor mounted for rotation relative to the stator and spaced from the stator in a non-contact fashion, and a plurality of magnets positioned to interact with the coils. A control circuit communicates with the coils to energize them in a sequence that causes the rotor to rotate, thereby spinning an output shaft. The motor output shaft is connected to a primary fan assembly for driving air past a heater element and out of the hair dryer. A secondary fan assembly and/or an air scoop are provided to redirect air towards the motor to maintain a cool operating temperature. The control circuit and the motor coil windings are designed to run the appliance at a relatively low current to accommodate a higher operating voltage. By achieving a low wattage in this manner, it is possible to provide the ability to quickly and selectively provide a non-heated air output interrupting the heated air output, sometimes referred to as a “cool shot” in the hair dryer industry.

In comparison to standard, known hair dryers and other appliances that use brush contact motors, appliances according to the present invention have the advantage of operating with significantly higher torque and velocity, and operating more efficiently and for longer life cycles.

### BRIEF DESCRIPTION OF THE DRAWINGS

The present invention will be better understood from reading the following description of non-limiting embodiments, with reference to the attached drawings, wherein below:

FIGS. 1A-1D are various views of a first preferred embodiment of the present invention;

FIGS. 2A-2F are various views of a brushless electric motor utilized in accordance with the present invention;

FIGS. 3A-3D are various views of a second preferred embodiment of the present invention;

FIGS. 4A-4F are various views of an air scoop, in relationship to a fan assembly and brushless electric motor, for use in cooling the brushless electric motor;

FIGS. 5A-5F are schematic sequences of commutation of the brushless electric motor utilized in accordance with the present invention;

FIGS. 6, 8, and 10-12 are schematic diagrams of various embodiments of an electronic control system/circuit for controlling the brushless electric motor and other appliance features; and

FIGS. 7, 9, and 13 are operational waveforms for the circuits in FIGS. 6, 8, and 12, respectively.

### DETAILED DESCRIPTION

The present invention is described herein with respect to a hair dryer as an example, but it is not limited to hair dryers and includes other portable appliances not associated with brushless motors in the prior art.

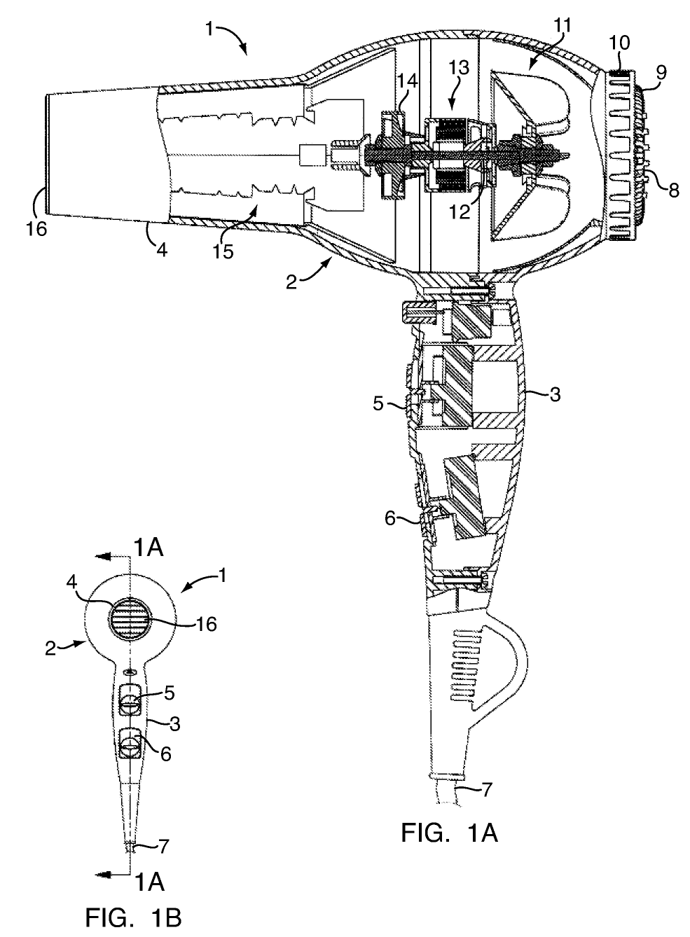

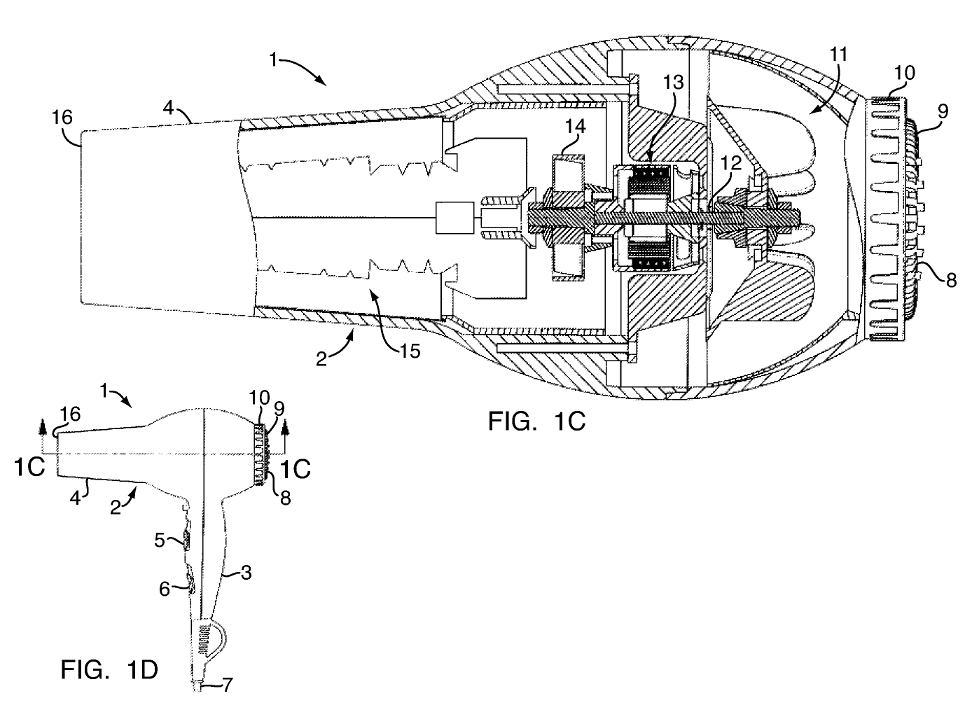

As shown in FIGS. 1A-1D, according to a first embodiment of the present invention, a hair dryer 1 has a housing 2 comprising a handle section 3 and a nozzle section 4. The handle section 3 has one or more control buttons 5, 6 for controlling various operating functions of the hair dryer. A power cord 7 provides electricity from an external AC source, e.g., an electrical receptacle or outlet. Incoming airflow enters through an intake port 8, which can have a screen filter 9 secured by a retainer ring 10. Airflow is drawn in by a rotating fan blade assembly 11, which is connected to a rotating shaft 12 driven by a brushless electric motor 13. The incoming airflow passes the fan blade assembly 11 and some of it is re-circulated toward the motor 13 by a secondary fan 14 for cooling the motor 13, while the rest of the airflow is pushed past a heater assembly 15 and out the discharge end 16 of the nozzle section 4 as heated air.

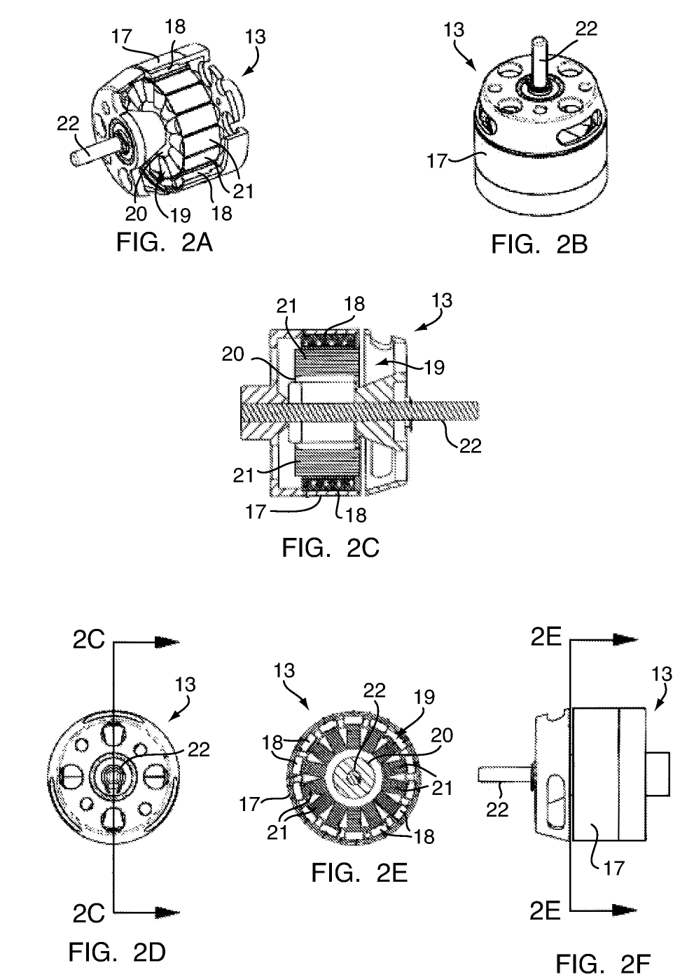

With reference to FIGS. 2A-2F, the brushless electric motor 13 includes a rotor 17 of a general cup shape having permanent magnets 18 located therein in an array. The rotor 17 is rotatably mounted to a stator 19 comprising a central hub 20 and a set of radially extending electromagnetic coils or windings 21. A drive shaft 22 rotates with the rotor 17. The rotor 17 is driven when the electromagnetic coils 21 are selectively energized in a predetermined sequence to create repulsion forces in combination with the permanent magnets, as discussed in more detail below. (As should be appreciated, the shaft 12 for driving the fan blade assembly 11 may be the same as the motor drive shaft 22, or it may be a separate shaft connected to the motor drive shaft 22.)

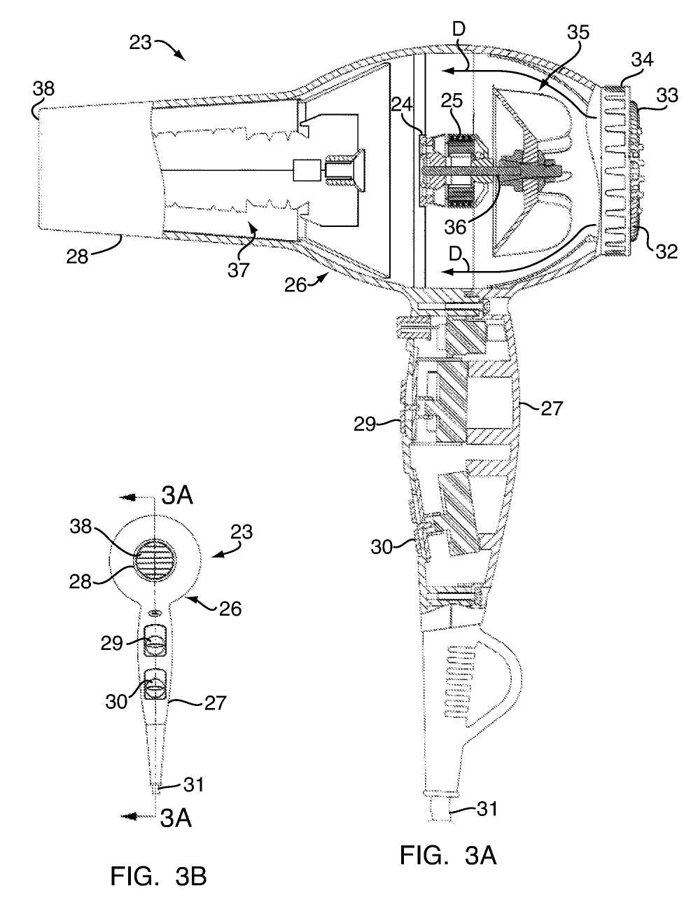

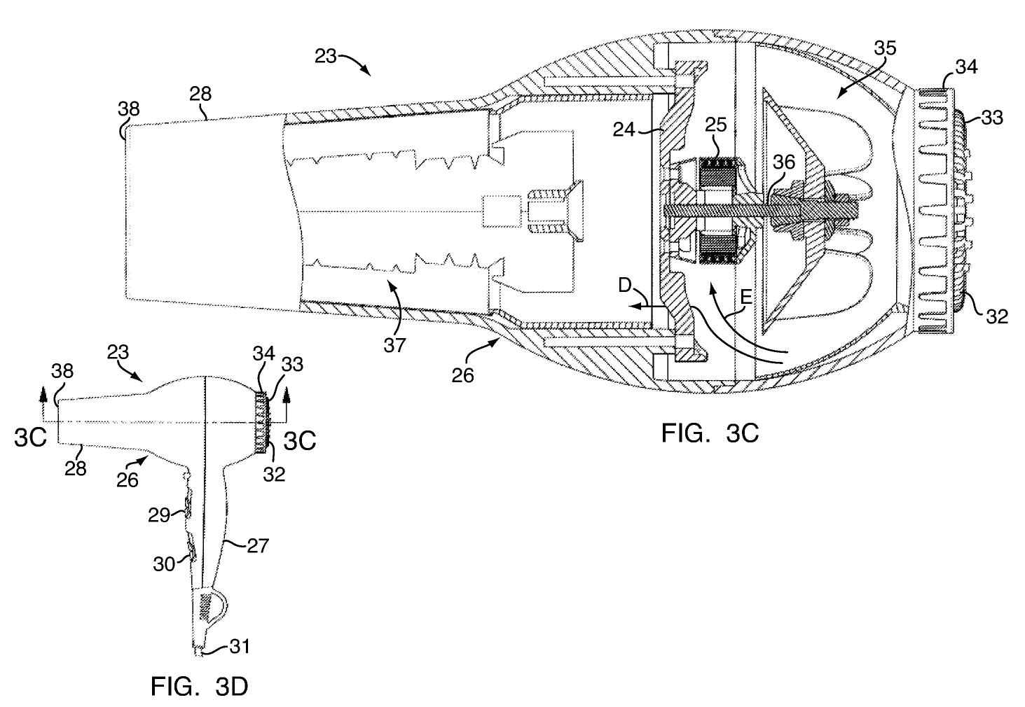

Turning now to FIGS. 3A-3D, according to a second embodiment of the present invention, a hair dryer 23 is essentially similar to that of the first embodiment, except that it does not include a secondary fan 14 for cooling. Instead, it includes a scoop 24 for redirecting airflow into a brushless electric motor 25. The hair dryer 23 includes a housing 26 comprising a handle section 27 and a nozzle section 28. The handle section 27 has one or more control buttons 29, 30 for controlling various operating functions. A power cord 31 provides electricity from an external source. Incoming airflow enters through the intake port 32, which can have a screen filter 33 secured by a ring 34. Air is drawn in by a rotating fan blade assembly 35, which is connected to a rotating shaft 36 driven by the brushless electric motor 25. The incoming airflow passes the fan blade assembly 35 and some of it is re-circulated toward the motor 25 by the air scoop 24 for cooling the motor 25, while the rest of the airflow is pushed past a heater assembly 37 and out the discharge end 38 of the nozzle 28 as heated air.

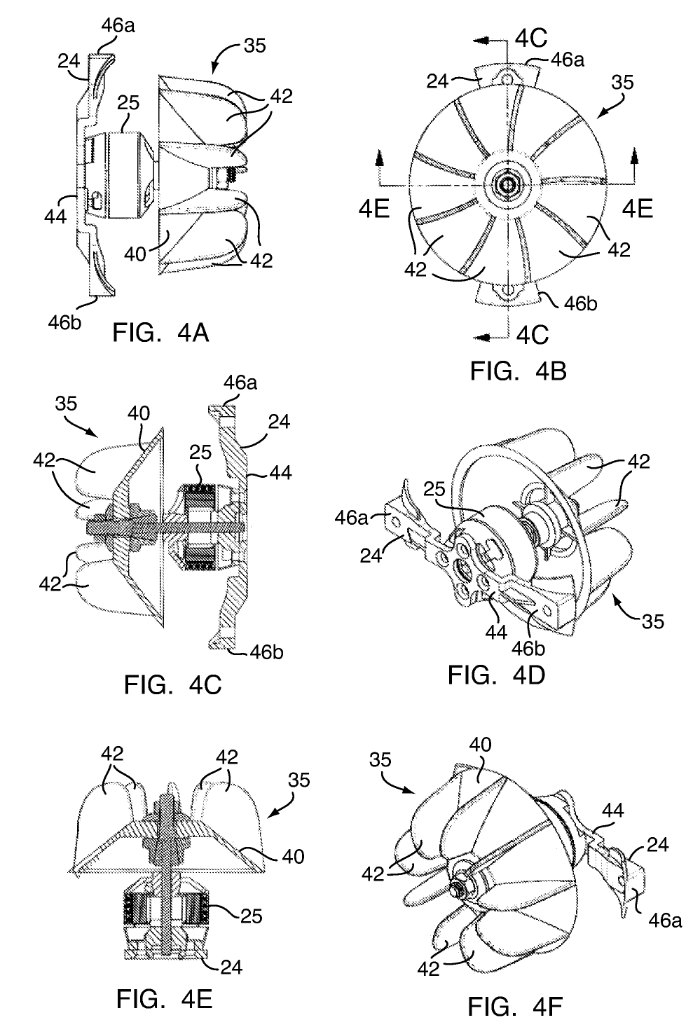

Details of the scoop 24, and its interrelationship with the brushless electric motor 25 and fan blade assembly 35, are shown in FIGS. 4A-4F. As indicated, the fan assembly 35 includes a fan of the type having a generally conical base portion 40 and a plurality of rounded fan blades 42 attached to the top surface of the base portion 40 and extending generally longitudinally rearwards towards the hair dryer intake port 32. In operation, when the fan assembly 35 is rotated, the fan assembly 35 draws air in through the intake port 32 and forward towards the heater assembly 37, as shown generally by flow line “D” in FIGS. 3A and 3C. Because most of the airflow travels through the radially outermost region of the hair dryer interior, in certain instances (e.g., depending on motor size, operational conditions, and the like) there may not be enough interaction between the airflow generated by the fan assembly and the brushless electric motor 25 for adequate cooling of the brushless electric motor 25. The scoop 24 redirects a portion of the intake airflow towards the brushless electric motor 25, for cooling purposes. In particular, the scoop 24, which is stationary, is attached to (or proximate to) the fore end of the brushless electric motor 25. The scoop 24 includes a cross-arm member 44 that extends across the interior of the housing 26. First and second scoop “hands” 46a, 46b, located at the distal ends of the cross-arm member 44, are positioned in the primary path of the intake airflow generated by the fan assembly 35. The hands 46a, 46b curve inwards toward the brushless electric motor 25. Thus, when the fan assembly 35 is activated for generating an air intake flow (e.g., flow line “D” in FIG. 3A), a portion of the airflow is redirected by the scoop hands 46a, 46b towards the brushless electric motor 25, as indicated by flow line “E” in FIG. 3C, for cooling the brushless electric motor 25.

Additional embodiments could include eliminating the air recirculation features such as the secondary fan or the air scoop, depending on operating conditions. Also, as indicated above, an air scoop may be used in addition to a secondary fan.

The fan blade assembly in either embodiment is readily detachable from the motor's output shaft for replacement or repair of components.

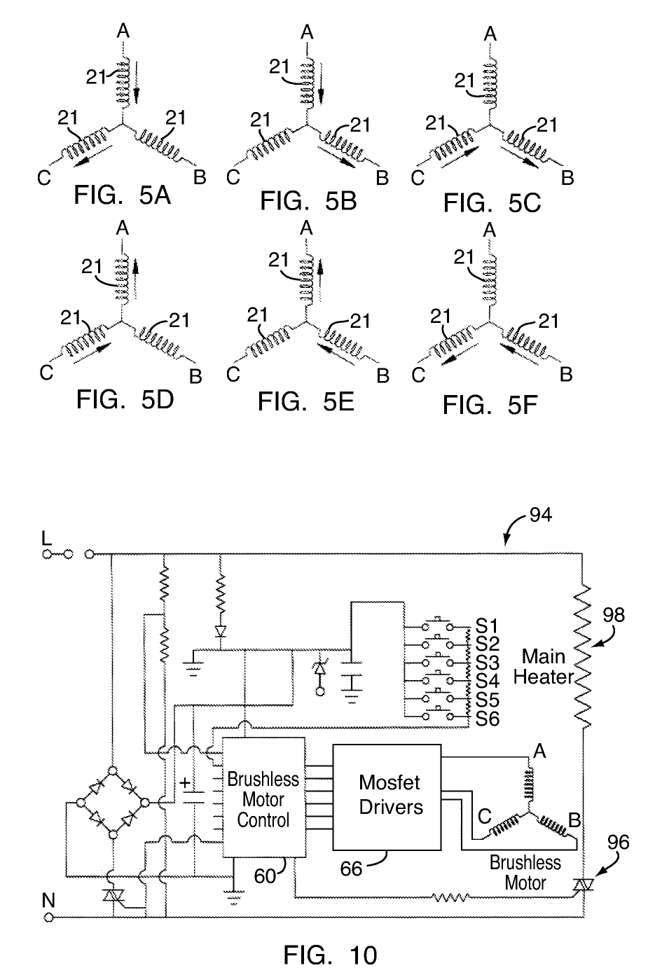

The brushless electric motor 13, 25 can be of any known type, including “outrunners” and “inrunners.” Outrunners, one example of which is shown in FIGS. 2A-2F, have an output shaft integral with the rotor, where the rotor forms the outer housing, so that they rotate together. (Here, the array of permanent magnets is disposed on the inner surface of the rotor, while the coils or windings are positioned on the stationary stator.) Inrunners have a stationary housing cover (i.e., stator), whereby the rotating output shaft, connected to a rotor inside the housing, extends from an opening in the housing cover. (Here, the coils or windings are connected to the stationary housing/stator, whereas the permanent magnets are arrayed about the interior rotor.) The brushless electric motors are three phase AC motors with permanent magnets and, typically, a Y-shaped coil configuration of three sets. (The coils/windings are connected to a central point, and power is applied to the remaining end of each coil.) The brushless motors are commutated in six steps every sixty degrees, as schematically illustrated in FIGS. 5A-5F, where coils A, B and C each represent a set consisting of a group of coils or a single coil 21. Two of the three sets are energized at a time, as indicated by the directional arrows in FIGS. 5A-5F, producing torque from the two energized sets.

Appliances such as hair dryers, hair clippers, and shavers require lightweight, powerful motors. These appliances are typically configured to utilize a standard mains voltage source for electrical power, e.g., 120 volts AC at 60 Hz. Small sized brushless motors typically run on 12V DC but can be designed to run at higher voltages like 36V DC. It is not possible to design a small, lightweight, powerful brushless motor to run on 120V DC because of winding limitations in such a small size motor frame. In a hair dryer application a brushless motor typically operates around 70 watts or higher. A conventional low voltage DC power supply needed to power a 70-watt load would be very large and expensive. Even an efficient switching power supply would be too large to fit in a hand held dryer for example.

In the past, for hair dryer appliances with conventional, brushed-type DC motors, voltage-dropping resistors were used as a reliable method to drop the mains voltage down to a lower voltage to operate the brushed DC motor through a normal bridge rectifier. Normally, 200 to 500 watts are dissipated in the hair dryer heater to drop the voltage for the DC motor. This type of power supply will not work for a brushless motor, however, because a filtered straight line DC power supply is required for the transistors or other power elements that are controlled to run the brushless motor. For example, as discussed below, six MOSFET transistors may be used to drive the 3-phase motor winding configuration, which require operation at a higher frequency than the typical 60 Hz main voltage supply. Also, with a dropping resistance supply there is high voltage during start up of the brushless motor. This is because the load current is not immediately applied due to the brushless motor start up sequence. The high voltage is almost equal to the line voltage of the mains power, which may damage the MOSFET transistors and prevent the motor from running.

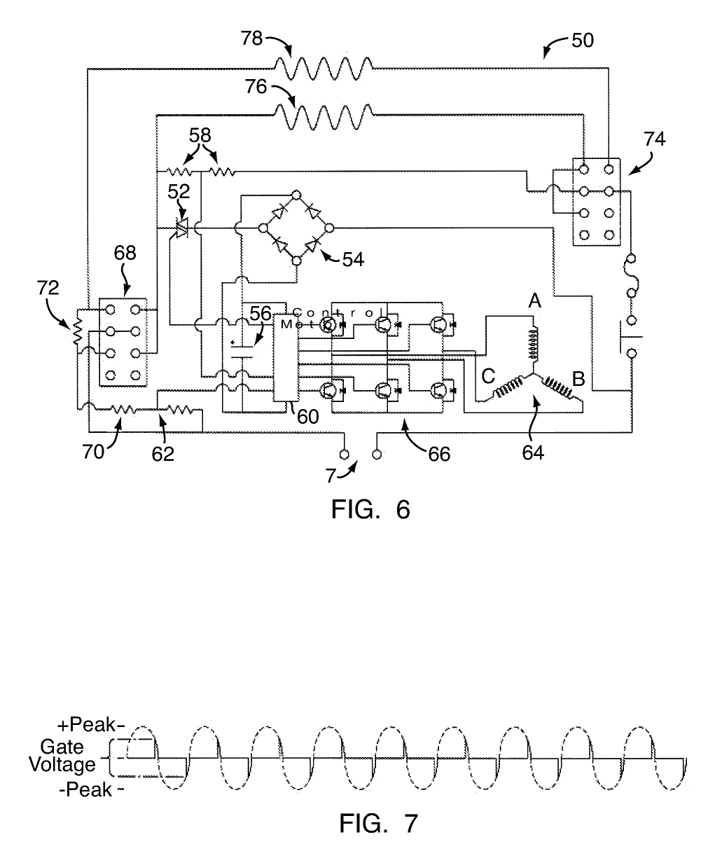

FIGS. 6-13 show various embodiments of an electronic control system/circuit for controlling the brushless electric motor 13, 25 and other electric features of the hair dryer or other appliance. The control system is especially adapted for use in appliances that have size and weight limitations (e.g., electric hair dryers), meaning that the control system is light weight, compact, and suitable for housing in the interior of an appliance in terms of heat dissipation, power usage, and the like.

FIG. 6 shows a first embodiment of the electronic control system or circuit 50. The system 50 includes a TRIAC 52, which is used to control the input of an AC supply voltage (e.g., from a power cord 7) to a bridge rectifier 54. The bridge rectifier 54 converts the input AC signal to rectified DC, which is then filtered by a filter capacitor 56. A zero cross-reference, supplied by a voltage divider 58, provides an analog input to a zero cross detector built into a brushless motor controller board 60. The zero cross detector is used to synchronize with the AC line at the point that the AC voltage signal crosses zero. The brushless motor controller board 60 delays the triggering of the TRIAC 52 until the voltage of the AC sine wave is at a safe operating voltage for the brushless control circuit 50. An example of the waveform can be seen in FIG. 7. Upon a start signal being received at an analog input 62 of the brushless motor controller 60, the controller starts the sequencing of an array of six MOSFET transistors 66. The start signal is generated by a voltage divider connected to a main power switch 68. Also, the voltage divider has a resistor 70 connected to a low setting of the main switch 68, and a resistor 72 connected between high and low settings allowing for resistors 70 and 72 to be in series. (In other words, at the low setting the circuit sees resistor 70 only, and at the high setting the circuit sees resistors 70 and 72 in series.) This enables two different voltage levels to be selectively applied to the analog input 62 of the brushless motor controller 60, depending on the position of the switch 68. The controller 60 identifies the voltage level of the analog input 62 and adjusts the motor speed by conventional pulse width modulation speed control, as commonly used in brushless motor control circuits. This circuit provides low voltage DC to the brushless motor controller in a small space that can fit into small, hand held appliances. Also, it does not require the normal 200 to 500 watts used to drop the voltage in a normal hair dryer that uses a DC motor with brushes. This allows for a cooler temperature when a cool shot switch 74 is opened, disconnecting the main heaters 76, 78.

Although MOSFETs 66 are shown for controlling the motor, other power elements could be used instead with suitable minor modifications to the control system.

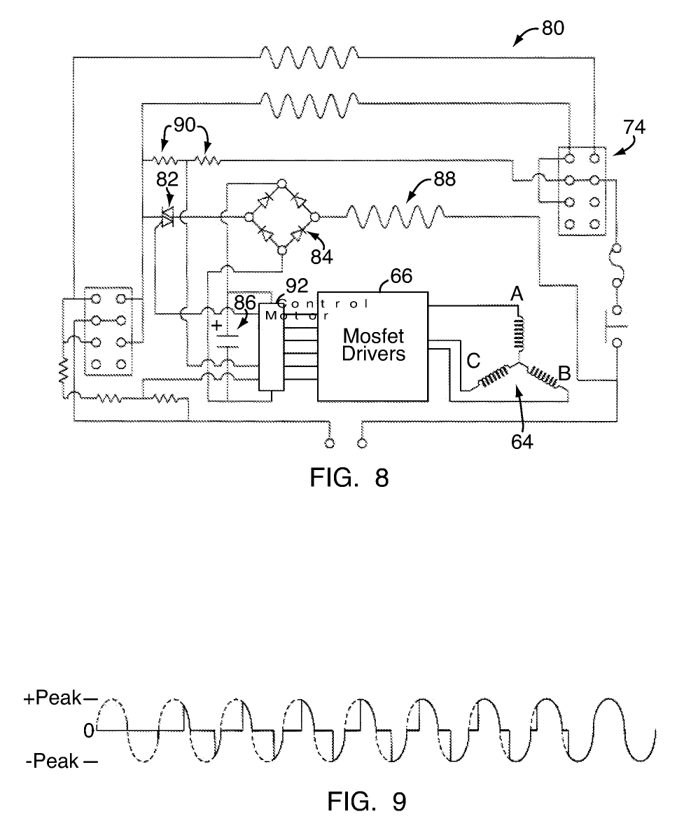

FIG. 8 shows a second embodiment of an electronic control system 80. The control system 80 includes a TRIAC 82 and a bridge rectifier 84. The TRIAC 82 controls the bridge rectifier 84, which converts the input AC power to rectified DC. The rectified DC voltage is filtered by a capacitor 86. The bridge rectifier 84 is connected to the TRIAC 82 on one side and a dropper resistor 88 on the other side. The dropper resistor 88 drops the voltage to the DC supply. A zero cross reference, supplied by a voltage divider 90, provides an analog input to a zero cross detector built into the brushless motor controller board 92. The brushless motor controller 92 delays the triggering of the TRIAC 82 until the voltage of the AC input sine wave is at a safe operating voltage for the brushless control circuit 80 to start up. The time delay triggering is gradually decreased until a full waveform is energized by the TRIAC 82. This provides the correct DC voltage without the high voltage during start up typically seen with a dropping resistor 88. FIG. 9 shows an example of the waveform. The time period that the TRIAC triggers a partial waveform to a full waveform can vary depending on the start up characteristics of the brushless motor and controller. This circuit allow for a stable running DC voltage using a dropping resistor with a TRIAC phase control circuit to protect the circuit from a damaging high start up voltage.

The electronic control system 94 shown in FIG. 10 has the same power control circuit as in FIG. 6 and uses the same phase control waveform as shown in FIG. 7. This circuit uses a TRIAC 96 to control the main heater 98. This allows for an array of momentary switches 100 to control the hair dryer functions, including speed, heat, cool shot, and turbo speed settings. It also allows for different displays, e.g., LED and LCD displays, not shown.

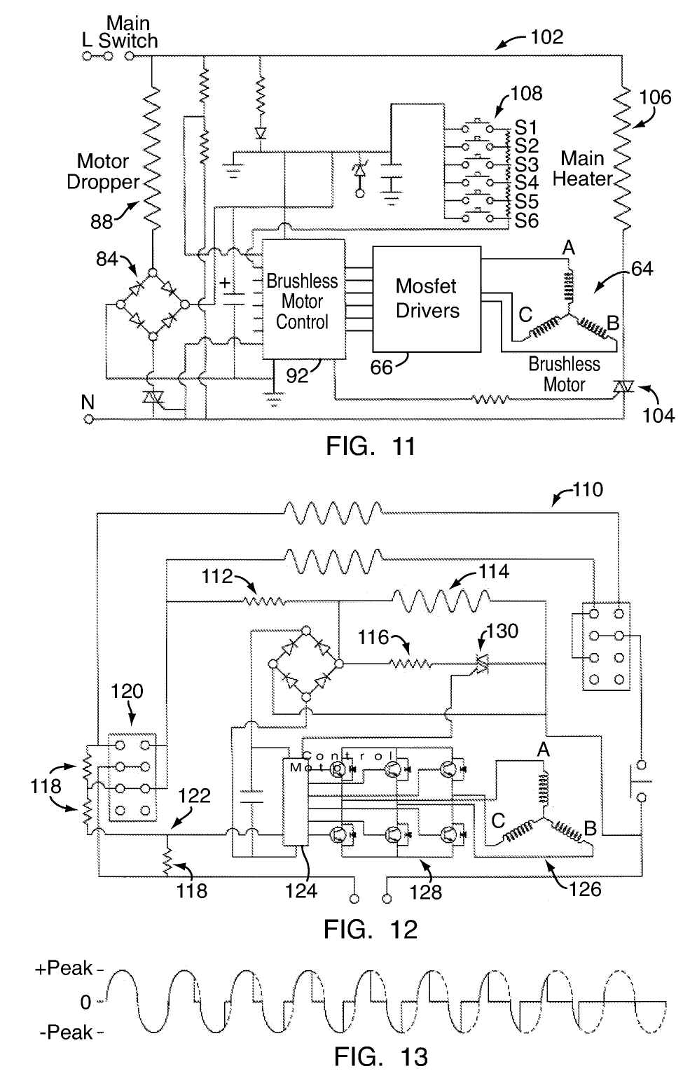

The control system 102 in FIG. 11 uses the same power control circuit as in FIG. 8 and the same phase control waveform as in FIG. 9. This circuit uses a TRIAC 104 to control the main heater 106. This allows for the provision of an array of momentary switches 108 to control the dryer functions like speed, heat, and cool shot, as well as a turbo speed setting. It also allows for different displays, e.g., LED and LCD displays, not shown.

FIG. 12 shows another control system or circuit 110 for the hair dryer 1, 23 or other appliance. The control system 110 uses a voltage divider dropper resistor network that includes a first resistor 112, a second (high power capacity) resistor 114, and a third resistor 116. The motor start signal is produced by a voltage divider 118 connected to the main power switch 120 and to an analog input 122 on the brushless motor controller 124. Just before the brushless motor controller 124 starts the motor 126 by sequencing the MOSFET drivers 128, the TRIAC 130 is activated with full wave firing, connecting resistor 116 in the circuit. This places a parallel load to resistor 114 on the circuit, which prevents a dangerous high voltage upon startup of the motor. As the brushless motor starts, the TRIAC 130 is deactivated after a fixed period of time allowing the correct DC voltage be applied to the brushless motor 126. The deactivation can be gradual, as shown in FIG. 13, by controlling the waveform, or a sudden disconnect after a fixed time period. This circuit eliminates the need for a zero cross detection circuit and a phase control circuit for the DC power supply to the brushless motor.

As indicated above, the present invention relates to portable electric appliances generally, by which it is meant an electrical device configured to perform a specific function for household or similar use, which is hand held or otherwise moveable (or intended to be moved) for regular use. In one embodiment, the appliance includes a housing, a brushless electric motor in the housing, and a work output member operably interfaced with the brushless electric motor. “Work output member” refers to an operational element of the appliance that is driven by the motor (indirectly or directly) to perform a mechanical work function of the appliance. Examples include the hair dryer fan assembly described above, hair clipper or shaver blades, the primary output spindle of a blender or food processor to which a blade assembly is attached by the user, or the like. The appliance also includes a control circuit in the housing for operating the brushless electric motor based on operation of a user control, e.g., an “on/off” switch or other control.

In another embodiment, as explained above with reference to the various control systems/circuits shown FIGS. 6-13, the control circuit limits voltage transients upon startup of the brushless motor. In particular, startup voltage transients are kept below a tolerance level of the control circuit for safe operation thereof, to avoid damage to the circuit elements. Additionally, the control circuit (e.g., when configured as discussed above) and brushless electric motor operate at a low wattage of less than 200 watts combined. This minimizes or reduces the amount of waste heat generated by the control circuit and motor, which may enhance operation of the appliance in certain operational modes, e.g., a cool shot air discharge from a hair dryer. It also facilitates placement of the control circuit in a small appliance housing.

Since certain changes may be made in the above-described electric appliances with brushless motors, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A portable electric appliance comprising:
a housing;
a brushless electric motor disposed in the housing;
a work output member operably interfaced with the brushless electric motor, said work output member being driven by a rotational output of the brushless electric motor for carrying out a work function of the appliance; and
a control circuit disposed in the housing for operating the brushless electric motor based on operation of a user control.

2. The portable electric appliance of claim 1 wherein the work output member is a primary fan assembly.

3. The portable electric appliance of claim 2 further comprising:
a secondary fan disposed in the housing and configured to direct air to the brushless electric motor for cooling purposes.

4. The portable electric appliance of claim 2 further comprising:
an air scoop disposed in the housing, wherein at least a portion of the air scoop is positioned in an airflow path of the primary fan assembly for directing air to the brushless electric motor, for cooling purposes.

5. The portable electric appliance of claim 1 wherein:
the appliance is a hand held hair dryer;
the work output member is a primary fan for discharging air out a nozzle end of the hair dryer; and
the user control comprises a switch for activating the hair dryer.

6. The portable electric appliance of claim 1 wherein:
the control circuit is configured to limit voltage transients in the control circuit upon startup of the brushless motor, said voltage transients being limited to below a tolerance level of the control circuit for safe operation thereof; and
the control circuit and brushless electric motor are configured to operate at a low wattage of less than 200 watts combined, whereby the amount of waste heat generated by the control circuit and motor is reduced.

7. The portable electric appliance of claim 1 wherein the control circuit comprises:
a brushless motor controller configured to control at least one switchable power element for electrically controlling the brushless motor;
an AC power input; and
a converter sub-circuit operably interfaced with the brushless motor controller and the AC power input for converting AC power present at the AC power input to lower DC power suitable for powering the brushless motor controller,
wherein the control circuit and motor are configured to operate at a low wattage of less than 200 watts combined, whereby the amount of waste heat generated by the control circuit and motor is reduced.

8. The portable electric appliance of claim 7 wherein the control circuit further comprises a voltage control sub-circuit configured to limit voltage transients in the control circuit upon startup of the brushless motor, said voltage transients being limited to below a tolerance level of the control circuit for safe operation thereof.

9. The portable electric appliance of claim 7 wherein:
the appliance is a hand held hair dryer;
the work output member is a fan assembly for discharging air out a nozzle end of the hair dryer, said hair dryer including a heating element for heating the air prior to its discharge out the nozzle; and
the user control includes a first setting for activating the fan, and a second setting for deactivating the heating element while the fan is running, for discharging air out the nozzle that is cooler than when the heater is activated, whereby operation in the second setting is enhanced because of the reduced amount of waste heat generated by the control circuit and brushless electric motor.

10. The portable electric appliance of claim 7 further comprising:
at least one of a cooling fan and an air scoop disposed in the housing and configured to direct air towards the brushless motor, for cooling purposes.

11. The portable electric appliance of claim 1 wherein said electric motor weighs about 50 grams.

12. The portable electric appliance of claim 1 wherein said electric motor has an operating life greater than 2000 hours.

13. The portable electric appliance of claim 1 wherein said electric motor operates at a rotational speed of up to 45,000 rpm.
